(19) United States
(12) Patent Application Publication
(10) Pub. No.: US 2021/0389258 A1
(43) Pub. Date: Dec. 16, 2021

(54) MATERIAL COUNTING METHOD AND COMPUTER DEVICE

(71) Applicant: TRIPLE WIN TECHNOLOGY(SHENZHEN) CO.LTD., Shenzhen (CN)

(72) Inventor: YING-JIA WANG, Shenzhen (CN)

(21) Appl. No.: 17/000,649

(22) Filed: Aug. 24, 2020

(30) Foreign Application Priority Data
Jun. 11, 2020 (CN) 202010531014.1

(51) Int. Cl. G01N 23/04; G06T 7/00; G06T 3/00; G06T 5/00; G06K 9/00; G06K 9/62

(52) U.S. Cl. CPC G01N 23/04; G06T 7/0002; G06T 3/00; G06T 5/00; G06T 2207/30242; G06K 9/00536; G06K 9/00503; G06K 9/6215; G06T 2207/10116; G06K 9/00201

(57) ABSTRACT

A method for examining and counting incoming materials includes receiving three-dimensional scanned images of the incoming materials, wherein the three-dimensional scanned image is taken by an X-ray machine. The three-dimensional scanned image is preprocessed, each type of material is identified by a pre-trained material classification model and other information relevant thereto is collected, and a first total number of materials of each type is counted to obtain the total number of materials of each type.

### CROSS-REFERENCE TO RELATED APPLICATIONS

This application claims priority to Chinese Patent Application No. 202010531014.1 filed on Jun. 11, 2020, the contents of which are incorporated by reference herein.

### FIELD

The subject matter herein generally relates to warehousing.

### BACKGROUND

Industrial automation is often used to count materials. The materials can be individually packaged (such as thermistors), or the materials can be stacked or packaged together. If the materials are stacked together, a user must lay out the stacked materials and count them. For example, the user may need to place the laid-out materials on a counter. But the packaged materials need to be unpacked, which is not meeting a continuous demand for high-efficiency automation in the production lines.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a computer device.

FIG. 2 is a block diagram of one embodiment of a materials counting system.

FIG. 3 illustrates a flowchart of one embodiment of a method for counting materials.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY™, flash memory, and hard disk drives. The term “comprises” means “including, but not necessarily limited to”; it specifically indicates open-ended inclusion or membership in a so-described combination, group, series, and the like.

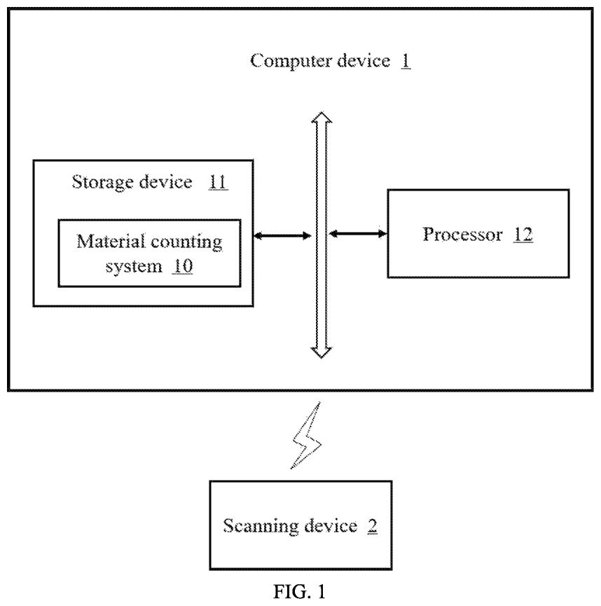

FIG. 1 is a block diagram of one embodiment of a computer device (computer device 1). Depending on the embodiment, the computer device 1 can include, but is not limited to, a storage device 11 and at least one processor 12. The storage device 11 and the at least one processor 12 communicate with each other through a system bus.

FIG. 1 illustrates only one example of the computer device 1, other examples can comprise more or fewer components than those shown in the embodiment, or have a different configuration of the various components.

It should be noted that the computer device 1 is only an example, and other existing or future computer devices that may be adapted to the present disclosure are included in the scope of protection of the present claims and are included here by reference.

In at least one embodiment, the storage device 11 may be used to store computer programs and various data of computer programs. For example, the storage device 11 may be used to store a material counting system 10 installed in the computer device 1. The storage device 11 may include Read-Only Memory (ROM), Programmable Read-Only Memory (PROM), Erasable Programmable Read-Only Memory (EPROM), One-time Programmable Read-Only Memory (OTPROM), Electronically Erasable Programmable Read-Only Memory (EEPROM), Compact Disc Read-Only Memory (CD-ROM) or other optical disk storage, magnetic disk storage, magnetic tape storage, or any other non-volatile computer-readable storage medium that can be used to carry or store data.

In some embodiments, the at least one processor 12 may be composed of integrated circuits. For example, it may be composed of a single packaged integrated circuit, or multiple integrated circuits with the same function or different functions, including one or more central processing units, microprocessors, a combination of digital processing chip, graphics processor, and various control chips. The at least one processor 12 is a control unit of the computer device 1, connects various components of the entire computer device 1 with various interfaces and lines, and executes programs or modules stored in the storage device 11 or instruction and calls up the data stored in the storage device 11 to execute various functions and process data of the computer device 1, for example, counting function.

In at least one embodiment, the computer device 1 can communicate with a scanning device 2. The scanning device 2 may be an X-ray scanning machine for scanning materials to obtain three-dimensional pictures of the materials and sending the three-dimensional pictures to the computer device 1. In one embodiment, the scanning device 2 may also be a three-dimensional laser scanner.

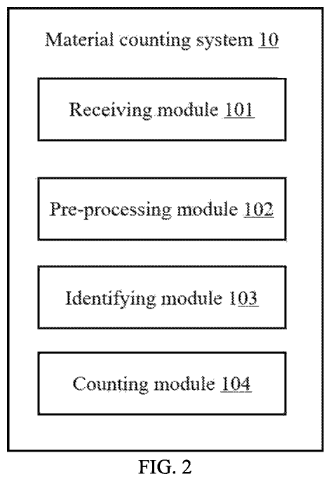

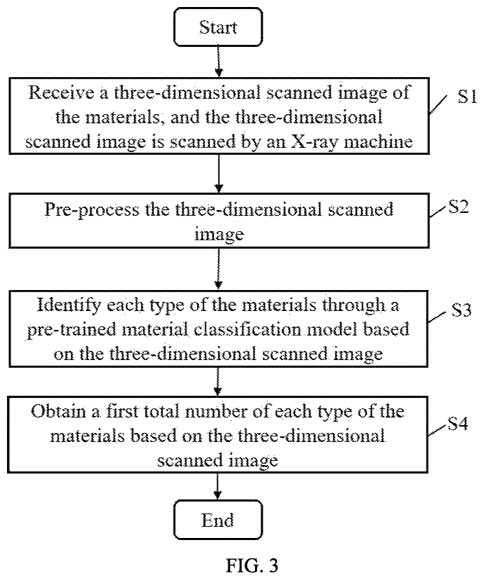

In at least one embodiment, the material counting system 10 may include one or more modules, the one or more modules are stored in the storage device 11 and are executed by at least one or more processors (e.g., the processor 12) to realize the counting function (referred to in FIG. 3). In at least one embodiment, the material counting system 10 can be divided into multiple modules based on the functions performed. Referring to FIG. 2, the multiple modules include a receiving module 101, a pre-processing module 102, an identifying module 103, and a counting module 104. The modules herein referred to are a series of computer-readable instruction segments that can be executed by at least one processor (such as the processor 12) and which can perform fixed functions and are stored in the storage device 11. In at least one embodiment, the functions of each module are illustrated in FIG. 3.

In at least one embodiment, the storage device 11 can pre-store standard material images.

In at least one embodiment, the integrated unit implemented in the form of a software function module may be stored in a non-volatile readable storage medium. The above-mentioned software function module includes one or more computer-readable instructions, and the computer device 1 or a processor (processor) implements part of the method of each embodiment of the present invention by executing the one or more computer-readable instructions, for example, FIG. 3 shows the method for materials counting.

In at least one embodiment, the at least one processor 12 may execute various application programs (such as the material counting system 10), program codes, etc. installed in the computer device 1.

In at least one embodiment, the storage device 11 stores program codes of computer programs, and the at least one processor 12 can call the program codes stored in the storage device 11 to perform related functions. For example, each module of the material counting system 10 in FIG. 2 is a program code stored in the storage device 11 and executed by the at least one processor 12, so as to realize the function of each module to achieve the purpose of materials counting function (see FIG. 3).

In at least one embodiment, the storage device 11 stores one or more computer-readable instructions, which are executed by the at least one processor 12 to implement the purpose of the disclosure. Specifically, the specific implementation method of the at least one processor 12 for the above-mentioned computer-readable instructions is described in FIG. 3.

FIG. 3 illustrates a flowchart of a method for materials counting.

In at least one embodiment, the method can be applied to the computer device 1. For the computer device 1 that needs to perform material counting, the function for material counting provided by the instant method can be directly integrated on the computer device 1 or can run on the computer device 1 in the form of a Software Development Kit (SDK).

Referring to FIG. 3, the method is provided by way of example, as there are a variety of ways to carry out the method. The method described below can be carried out using the configurations illustrated in FIG. 1, for example, and various elements of these figures are referenced in explaining the method. Each block shown in FIG. 3 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block 51.

At block 51, the receiving module 101 receives a three-dimensional scanned image of the materials, the three-dimensional scanned image being taken by an X-ray machine.

In at least one embodiment, when there is a need to count the materials, a user can put the materials into the X-ray machine for scanning. The X-ray machine includes multiple cameras and a conveying device. After the material is placed on the conveying device, the multiple cameras are activated to capture images of the materials from multiple angles. The conveying device can input the materials into the X-ray machine and output the materials from the X-ray machine. The conveying device can use springs, clips, gears, and chained devices for inputting the materials into the X-ray machine and outputting the materials from the X-ray machine. The materials can also be placed manually.

In at least one embodiment, stacks, or piles of the same material can be placed on the conveying device at the same time, or stacks and piles different types of materials can be placed on the conveying device at the same time.

In at least one embodiment, the X-ray machine can scan the materials and obtain three-dimensional scanned images and send the three-dimensional scanned images to the computer device 1.

At block S2, the pre-processing module 102 can pre-process each three-dimensional scanned image.

In at least one embodiment, it is necessary to preprocess the three-dimensional scanned image in order to eliminate irrelevant information from the three-dimensional scanned image. Then the pre-processing module 102 can store useful and real information of the three-dimensional scanned image, and enhance the quality of related information, and simplify the data to the utmost extent. Such enhancement can include improving the reliability of feature extraction, image segmentation, image matching, and image recognition. Specifically, the pre-processing of the three-dimensional scanned images includes:

(1) graying the three-dimensional scanned images. Methods for graying the three-dimensional scanned images can include a component method, maximum value method, average method, and weighted average method.

(2) performing a geometric transformation on the grayed three-dimensional scanned images. For example, the pre-processing module 102 can process the three-dimensional scanned image through geometric transformations such as translation, transposition, mirroring, rotation, zooming, etc., to correct system errors of the X-ray machine and random errors of a position of the X-ray machine (for example, imaging angle, perspective relationship, and even lens of the X-ray machine). In addition, in order to avoid pixels of an output image being mapped to non-integer coordinates of an input image after performing geometric transformation of the three-dimensional scanned image, a grayscale interpolation by an algorithm can be used to process the transformed image. For example, the grayscale interpolation algorithm includes a nearest neighbor interpolation algorithm, a bilinear interpolation algorithm, and a bicubic interpolation algorithm.

(3) performing image enhancement on the three-dimensional scanned images. An overall or local characteristic of the three-dimensional scanned image can be deliberately emphasized, an unclear original made clear, or some interesting features emphasized. The differences in features between different objects of the scanned image can be expanded, and irrelevant or uninteresting features suppressed. Image quality can be improved, the amount of gathered information increased, the image interpretation and recognition ability strengthened, and the needs of some specific analysis met. Such image enhancement algorithms may include spatial domain method and frequency domain method.

At block S3, the identifying module 103 can identify each type of material through a pre-trained material classification model, based on the three-dimensional scanned image.

In at least one embodiment, when different types of materials are to be processed, the identifying module 103 can identify types of materials and count a first total number of such types of materials.

In at least one embodiment, the identifying module 103 can identify types of materials through a pre-trained material classification model based on the three-dimensional scanned images can include:

(a) the identifying module 103 can identify multiple materials in a three-dimensional scanned image.

In at least one embodiment, the three-dimensional scanned image may include multiple materials of different types, the identifying module 103 can identify each material in the three-dimensional scanned image and then classify the identified material.

(b) the identifying module 103 can obtain several sub-images by cutting and segmenting the three-dimensional scanned image according to the multiple materials.

In at least one embodiment, the identifying module 103 can cut the three-dimensional scanned image containing multiple materials into several sub-images. Each of the sub-image contains one material. For example, an image A might contain material a, material b, and material c. The identifying module 103 can cut the image A into three sub-images. For example, a sub-image A1 containing material a, a sub-image A2 containing material b, and a sub-image A3 containing material c.

(c) the identifying module 103 can obtain types of materials by inputting several sub-images into the pre-trained material classification model.

In at least one embodiment, a method for training the material classification model can include:

1) obtain positive samples and negative samples of the images, and mark each of the positive samples with a label so that the positive samples carry material type labels.

For example, 500 images corresponding to a thermistor, capacitor, and diode respectively can be selected, and the category for each image can be marked. The identifying module 103 can use “1” as the material type label of the thermistor, and “2” as the material type label of the normal load, with “3” as the material type label of the low load.

2) The identifying module 103 can randomly divide the positive samples and the negative samples into a training set of a first preset ratio and a verification set of a second preset ratio, and the material classification model is trained using the training set, the verification set can be used to verify the accuracy of the material classification model.

In at least one embodiment, the identifying module 103 can distribute the training samples in the training set of different types to different folders. For example, distribute the training samples of the thermistor to a first folder, training samples of the capacitor to a second folder, and training samples of the diode to a third folder. Then the identifying module 103 can extract the training samples of the first preset ratio (for example, 70%) from different folders as the total training samples for training the material classification model, and take the remaining second preset ratios from different folders (for example, 30%) of the training samples as the total test samples to verify the accuracy of the material classification model.

3) If the accuracy rate is greater than or equal to a preset accuracy rate, the training ends, and the trained material classification model is used as a classifier authority to identify the material category. If the accuracy rate is less than the preset accuracy rate, then the identifying module 103 can increase the number of positive samples and the number of negative samples to retrain the material classification model until the accuracy rate is greater than or equal to the preset accuracy rate.

In at least one embodiment, the material counting method further includes calculating a size of the materials of the three-dimensional scanned image. A method for calculating the size of the materials of the three-dimensional scanned image can include: obtaining a distance between a focal point of the scanning device 2 and the material in the image; obtaining a pixel size of each material; obtaining a minimum pixel size of a reference image and a size of the reference image; and calculating the size of the material according to the distance, the pixel size of the material, and the size of the reference image. It can be understood that the method for calculating the sizes of the plurality of materials is not limited to the above method.

At block S4, the counting module 104 can obtain a first total number of each type of the materials based on the three-dimensional scanned image.

In at least one embodiment, the counting module 104 can count the first total number of materials after classifying the materials.

In at least one embodiment, the material counting method further can include calculating qualified and non-qualified rates of the materials. The counting module 104 can determine whether the materials meet requirements by comparing the sub-images with pre-stored standard material images, count a second total number of materials that meet the requirements, and calculate the qualified rate of the materials according to the second total number divided by the first total number.

In at least one embodiment, the counting module 104 can calculate a similarity value between a sub-image and the pre-stored standard material image and compare the similarity value with a preset similarity value. When the similarity value is greater than or equal to the preset similarity value, it is determined that the materials meet the requirements. When the similarity value is less than the preset similarity value, it is determined that that the material does not meet the requirements.

In at least one embodiment, the disclosed method for material counting does not need to disassemble the packaging, does not change the state of new and incoming material, and does not need to open the entire material to another scroll bar of the counter, and then take it back after counting, which saves time. In addition, the material counting method can also obtain information as to material sizes.

It should be emphasized that the above-described embodiments of the present disclosure, including any embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer device comprising:
at least one processor, and
a storage device that stores one or more programs, which when executed by the at least one processor, causes the at least one processor to:
receive a three-dimensional scanned image of materials, wherein the three-dimensional scanned image is scanned by an X-ray machine;
pre-process the three-dimensional scanned image;
identify each type of the materials through a pre-trained material classification model based on the three-dimensional scanned image; and
obtain a first total number of each type of the materials based on the three-dimensional scanned image.

2. The computer device based on claim 1, wherein the at least one processor is further caused to:
gray the three-dimensional scanned image;
perform a geometric transformation on the grayed three-dimensional scanned image; and
perform image enhancement on the three-dimensional scanned image.

3. The computer device based on claim 1, wherein the at least one processor is further caused to:
identify a plurality of materials in the three-dimensional scanned image;
obtain a plurality of sub-images by cutting the three-dimensional scanned image according to the identified materials; and
obtain types of materials by inputting the plurality of sub-images to the pre-trained material classification model.

4. The computer device based on claim 1, wherein the at least one processor is further caused to:
calculate a qualified rate of the materials.

5. The computer device based on claim 4, wherein the qualified rate of the materials is calculated by:
determining whether the materials meet requirements by comparing the sub-images with pre-stored standard material images;
counting a second total number of the materials that meet the requirements; and
calculating the qualified rate of the materials according to the second total number divided by the first total number.

6. The computer device based on claim 5, wherein the at least one processor is further caused to:
calculate a similarity value between a sub-image and the pre-stored standard material image;
compare the similarity value with a preset similarity value;
in response that the similarity value is greater than or equal to the preset similarity value, determine that the materials meet the requirements; or
in response that the similarity value is less than the preset similarity value, determine that the material does not meet the requirements.

7. A material counting method applicable in a computer device, the method comprising:
receiving a three-dimensional scanned image of materials, wherein the three-dimensional scanned image is scanned by an X-ray machine;
pre-processing the three-dimensional scanned image;
identifying each type of the materials through a pre-trained material classification model based on the three-dimensional scanned image; and
obtaining a first total number of each type of the materials based on the three-dimensional scanned image.

8. The method based on claim 7, wherein the method further comprises:
graying the three-dimensional scanned image;
performing a geometric transformation on the grayed three-dimensional scanned image; and
performing image enhancement on the three-dimensional scanned image.

9. The method based on claim 7, wherein the method further comprises:
identifying a plurality of materials in the three-dimensional scanned image;
obtaining a plurality of sub-images by cutting the three-dimensional scanned image according to the identified materials; and
obtaining types of materials by inputting the plurality of sub-images to the pre-trained material classification model.

10. The method based on claim 7, wherein the method further comprises:
calculating a qualified rate of the materials.

11. The method based on claim 10, wherein the method further comprises:
determining whether the materials meet requirements by comparing the sub-images with pre-stored standard material images;
counting a second total number of the materials that meet the requirements; and
calculating the qualified rate of the materials according to the second total number divided by the first total number.

12. The method based on claim 11, wherein the method further comprises:
calculating a similarity value between a sub-image and the pre-stored standard material image;
comparing the similarity value with a preset similarity value;
in response that the similarity value is greater than or equal to the preset similarity value, determining that the materials meet the requirements; or
in response that the similarity value is less than the preset similarity value, determining that the material does not meet the requirements.

13. A non-transitory storage medium having stored thereon instructions that, when executed by at least one processor of a computer device, causes the at least one processor to perform a material counting method, the method comprising:
receiving a three-dimensional scanned image of materials, wherein the three-dimensional scanned image is scanned by an X-ray machine;
pre-processing the three-dimensional scanned image;
identifying each type of the materials through a pre-trained material classification model based on the three-dimensional scanned image; and
obtaining a first total number of each type of the materials based on the three-dimensional scanned image.

14. The non-transitory storage medium based on claim 13, wherein the method further comprises:
graying the three-dimensional scanned image;
performing a geometric transformation on the grayed three-dimensional scanned image; and
performing image enhancement on the three-dimensional scanned image.

15. The non-transitory storage medium based on claim 13, wherein the method further comprises:
identifying a plurality of materials in the three-dimensional scanned image;
obtaining a plurality of sub-images by cutting the three-dimensional scanned image according to the identified materials; and
obtaining types of materials by inputting the plurality of sub-images to the pre-trained material classification model.

16. The non-transitory storage medium based on claim 13, wherein the method further comprises:
calculating a qualified rate of the materials.

17. The non-transitory storage medium based on claim 16, wherein the method further comprises:
determining whether the materials meet requirements by comparing the sub-images with pre-stored standard material images;
counting a second total number of the materials that meet the requirements; or
calculating the qualified rate of the materials according to the second total number divided by the first total number.

18. The non-transitory storage medium based on claim 17, wherein the method further comprises:
calculating a similarity value between a sub-image and the pre-stored standard material image;
comparing the similarity value with a preset similarity value;
in response that the similarity value is greater than or equal to the preset similarity value, determining that the materials meet the requirements; and
in response that the similarity value is less than the preset similarity value, determining that the material does not meet the requirements.
